(19) United States
(12) Patent Application Publication
(10) Pub. No.: US 2016/0055722 A1
(43) Pub. Date: Feb. 25, 2016

(54) SYSTEM AND METHOD OF GENERATING ADDITIONAL POKER TOURNAMENT PRIZE POOLS AND NUMBER OF PAYOUTS

(71) Applicant: Bubbleproof Me, LLC, Las Vegas, NV (US)

(72) Inventor: Robert V. Nardizzi, Las Vegas, NV (US)

(21) Appl. No.: 14/466,261

(22) Filed: Aug. 22, 2014

(51) Int. Cl. G07F 17/32

(52) U.S. Cl. CPC G07F 17/3276; G07F 17/3293; G07F 17/3244

(57) ABSTRACT

Players may pay an optional fee that provides a payout should the player finish the tournament in one of one or more finishing spots as determined by an operator. The secondary payout pool may be reserved for a certain number of high finishing eligible players or low finishing eligible players. The secondary payout pool may be randomly distributed to a certain number of eligible players. The secondary payout spots may be limited to non-primary payout spots or not. The operator is able to customize the distribution of the secondary payout pool. Tracking may be accomplished using Apps running on smart phone and/or tablets.

### FIELD OF THE INVENTION

The embodiments of the present invention relate to a system and method of increasing poker tournament pools and number of payouts.

### BACKGROUND

With television coverage and online games, poker has become extremely popular. Accordingly, poker games attract larger player pools and prize monies. Poker tournaments have seen dramatic increases in the number of entrants and prize pools. In a typical poker tournament, approximately 10% of the top finishing entrants will receive a payout. For example, if 100 players enter a poker tournament, the final or top 10 players will receive a payout. Thus, it can be a daunting task to finish in the money of a poker tournament.

Thus, it would be advantageous to develop a secondary poker pool payable at the discretion of the operator.

### SUMMARY

Accordingly, a first embodiment of the present invention is a method of conducting a poker tournament comprising: accepting a poker tournament entry fee; determining a primary payout pool and payout scheme based on a number of poker tournament entry fees accepted, said payout scheme including a number of finishing spots to be paid; accepting optional secondary fees from players; recording each player paying the optional secondary fee and each such player's finishing spot; and determining a secondary payout pool and payout scheme based on the number of optional secondary fees accepted, said secondary payout pool limited to players paying the optional secondary fee.

Another embodiment of the present invention is an electronic poker system configured for play over a computer network accessible by player terminals, said terminals including at least a display and user interface, comprising: computer means programmed to: accept a poker tournament entry fee; determine a primary payout pool and payout scheme based on a number of poker tournament entry fees accepted, said payout scheme including a number of finishing spots to be paid; accept optional secondary fees from players; record each player paying the optional secondary fee and each such player's finishing spot; and determine a secondary payout pool and payout scheme based on the number of optional secondary fees accepted, said secondary payout pool limited to players paying the optional secondary fee.

Another embodiment of the present invention involves a poker tournament system comprising:

one or more poker tables, said one or more poker tables each including an automatic shuffler, chip rack and dealer station; a poker tournament registration system proximate to said one or more poker tables, said poker tournament registration system including at least a computer terminal and printer, and configured to: (i) record payment of poker tournament entry fees and optional secondary fees, (ii) generate a receipt including an identifier and/or data code for at least each player paying the optional secondary fee, (iii) determine a primary payout scheme based on number of accepted poker tournament entry fees and (iv) determine a secondary payout scheme based on number of accepted secondary fees; a display in communication with said poker tournament registration system, said display for displaying poker tournament information including said primary payout scheme and secondary payout scheme; and one or more mobile devices configured to read said identifiers and/or data codes from said receipts as players, having paid the optional secondary fee, are eliminated from said poker tournament and associating said identifiers and/or data codes with finishing spots of said players such that said players may be paid, if eligible, according to said secondary payout scheme.

With the embodiments of the present invention, players may pay an optional fee that provides a payout should the player finish the tournament in one of one or more spots as determined by the operator. In a first embodiment, the secondary payout pool is reserved for a certain number of high finishing players outside of the primary payout pool. In another embodiment, the secondary payout pool is reserved for a certain number of low finishing players. In another embodiment, the secondary payout pool is randomly distributed to a certain number of players paying the optional secondary fee and finishing outside of the primary payout pool or within the primary payout pool. With the embodiments of the present invention, the operator is able to customize the distribution of the secondary payout pool.

Other variations, embodiments and features of the present invention will become evident from the following detailed description, drawings and claims.

### BRIEF DESCRIPTION OF THE DRAWINGS

FIG. 1 illustrates a conventional payout scheme for a poker tournament;

FIGS. 2A and 2B illustrate secondary payout pool schemes for the poker tournament of FIG. 1 according to the embodiments of the present invention;

FIG. 3 illustrates a flow chart detailing a method of conducting a poker tournament according to the embodiments of the present invention;

FIG. 4 illustrates a computer network for facilitating an online poker tournament according to the embodiments of the present invention;

FIG. 5 illustrates a poker tournament system according to the embodiments of the present invention; and

FIG. 6 illustrates a flow chart of a method of tracking players as they are eliminated or knocked out from the tournament according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention may involve both hardware and software elements which portions are described below in such detail required to construct and operate the case according to the embodiments of the present invention.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The embodiments of the present invention are ideal for poker tournaments and the disclosure below focuses on poker. However, those skilled in the art will recognize that other tournament games may benefit from the embodiments as well.

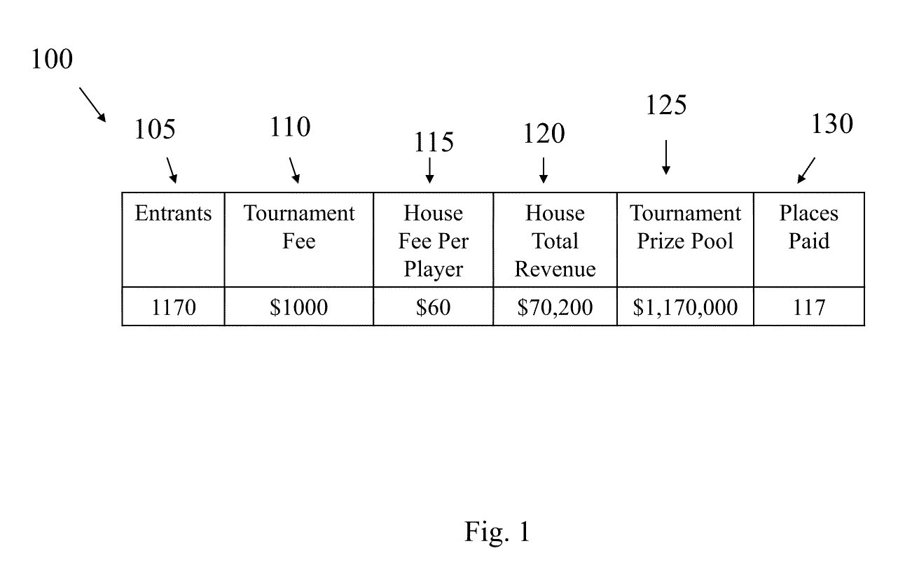

FIG. 1 shows a conventional payout scheme 100 for a conventional poker tournament. The payout scheme is based on 1170 entrants 105 each paying $1000 tournament entry fee 110 plus a $60 house fee 115 creating a primary payout pool of $1,1700,000 (1170×$1000) 120. The house collects $70,200 (1170×$60) as its fee 125. The house may also take a percentage (e.g., 2%-10%) of each entry fee for conducting the poker tournament rather than the additional fee on top of the entry fee. In this example, as shown, the top 117 places 130 are paid. Normally first place is paid approximately 50% of the prize pool while the remaining 116 players share the other 50%. The term “on the bubble” is the final spot(s) immediately preceding the start of payouts. In this example, the player finishing in the 118^{th} spot is said to finish on the bubble. More generally, the term bubble means any spot after and near the first payout spot. With the top 117 spots being paid, spots 118-125 (or any other suitable range) may be considered bubble spots (i.e., finishing spots close to receiving a payout but receiving nothing). The embodiments of the present invention are directed to generating an additional payout pool, independent of the primary payout pool, and additional payouts.

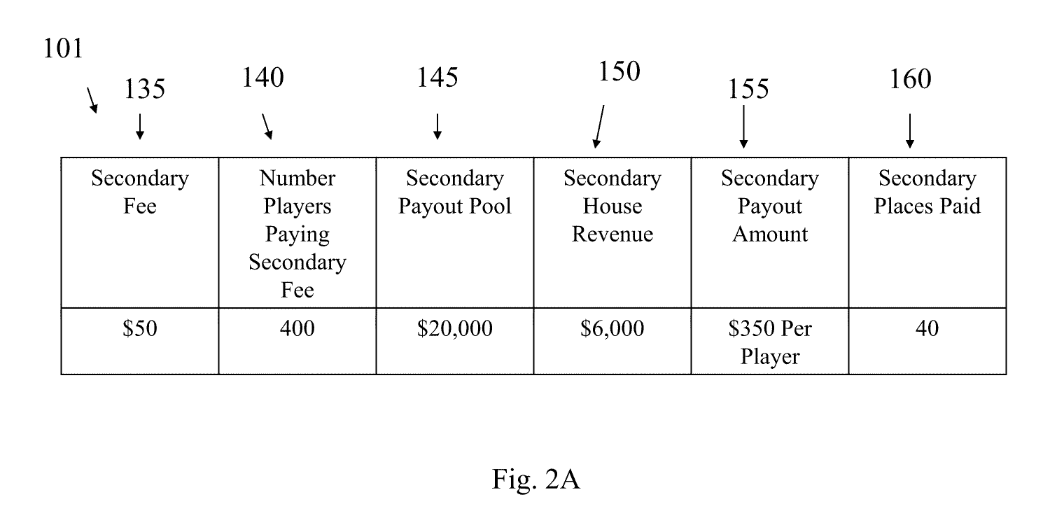

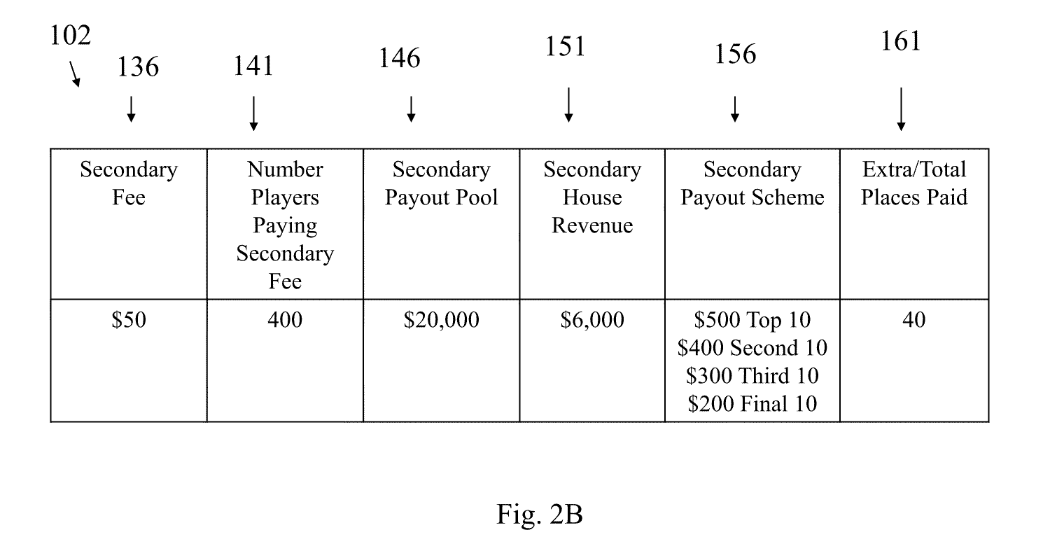

The embodiments of the present invention create additional payouts to players paying a optional secondary or extra fees in addition to the conventional poker tournament entry fees which are used to generate the primary payout pool. In one embodiment, the optional secondary fee is a pre-established percentage (e.g., 5%) of the tournament entry fee. Those skilled in the art will recognize that any percentage (1%-20% or more) of the entry fee or a fixed fee may be used to establish the optional secondary fee and is within the spirit and scope of the present invention. FIG. 2A shows a chart 101 with a 5% optional secondary fee ($50) 135 based on the $1000 entry fee 110. FIG. 2A assumes that 400 players elect to pay the optional secondary fee 135 generating $20,000 (400×$50) 140. In one embodiment, 70% of the collected optional secondary fees 135 are used to fund the secondary payout pool while the balance is held by the house as revenue. In this instance, a secondary payout pool of $14,000 (70%×$20,000) 145 is generated and $6,000 (30%×$20,000) 150 is collected by the house as revenue. The embodiments of the present invention contemplate numerous schemes for distributing the secondary payout pool.

It must first be determined how many players shall be eligible to receive an award from the secondary payout pool. In one embodiment, as with the payout scheme associated with many poker tournaments, 10% of the players paying the optional secondary fee are eligible to receive an award from the secondary payout pool. It is well understood that more or less than 10% of the players paying the optional fee may be eligible for an award. Ultimately the operator shall decide how many players are eligible. As shown in FIG. 2A, the $14,000 secondary payout pool is evenly distributed by awarding $350 ($14,000/40) to each of the 40 (10%×400) players 160. In another embodiment, the highest or lowest finishing eligible player is awarded the entire secondary payout pool (minus the percentage of the secondary payout pool collected by the operator as revenue).

FIG. 2B shows a chart 102 with a 5% optional secondary fee ($50) 136 based on the $1000 entry fee 110. FIG. 2B assumes that 400 players elect to pay the optional secondary fee 136 generating $20,000 (400×$50) 141. In one embodiment, 70% of the collected optional secondary fees 136 are used to fund the secondary payout pool. In this instance, a secondary pool of $14,000 (70%×$20,000) 146 is generated and $6,000 (30%×$20,000) 151 is collected by the house. As shown in FIG. 2B, the $14,000 secondary payout pool is distributed via a series of tiers by awarding $500 to tier 1 players finishing in spots 1-10; $400 to tier 2 players finishing in spots 11-20; $300 to tier 3 players finishing in spots 21-30; and $200 to tier 4 players finishing in spots 31-40. In other words, the eligible players finishing in the top 40 spots outside of the primary pool payout receive an award. The tiers may be flipped so that lower finishing players receive the higher payouts. In other embodiments, eligible players finishing in any spot, including within the primary pool payout spots, receive a secondary pool award. In such an embodiment, a player finishing in a primary payout spot is paid a portion of the primary payout pool and remains eligible for a portion of the secondary payout pool.

With the secondary pool, operators may configure the payouts in any number of ways to reward players for paying the secondary optional fee. Depending on the tournament and operator, there may be a limit to the number of players able to pay the optional secondary fee. Accordingly, once a pre-established number or percentage of players pays the optional secondary fee, the operator may close the secondary payout pool. No matter the embodiment, players not paying the optional secondary fee are not eligible for any secondary payout pool.

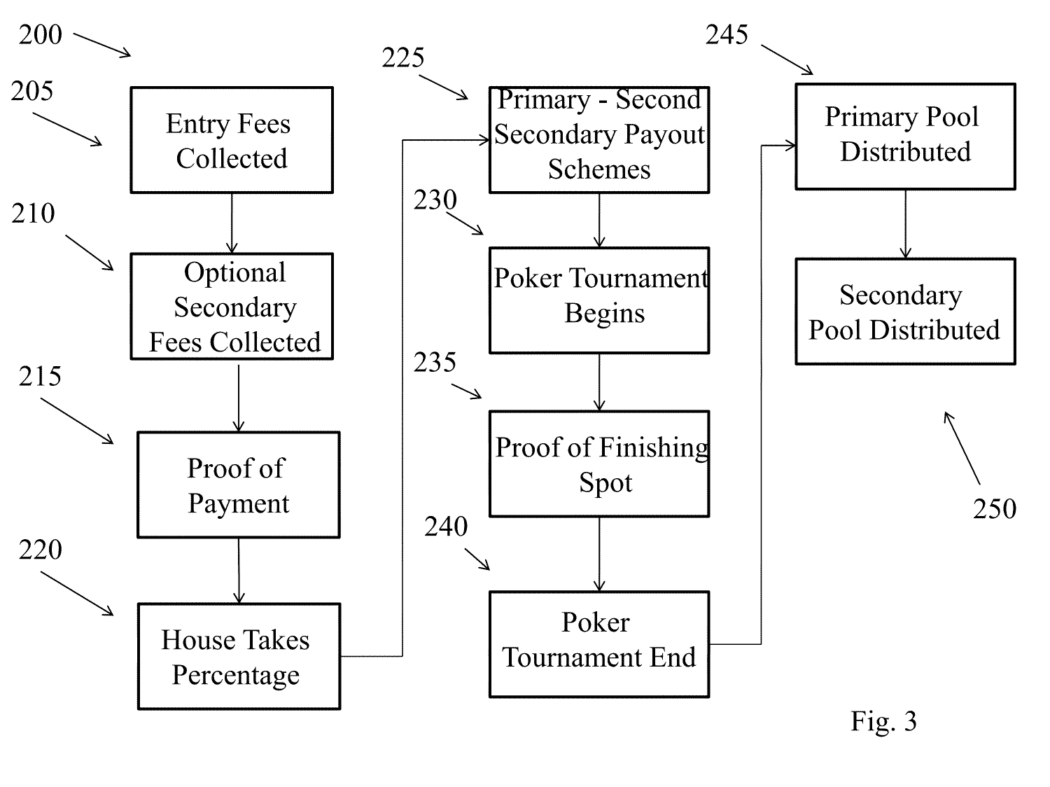

FIG. 3 shows a flow chart 200 detailing a method of conducting a poker tournament according to the embodiments of the present invention. At 205, poker tournament entry fees are collected. At 210, optional secondary fees are collected. At 215, players paying the optional secondary fee are provided with proof of payment and the house records the payment. Recordation may include entry into a digital database comprising a player's name and proof of identification. The proof of payment may comprise a special token, paper receipt, voucher or similar tangible item which allows the house confirm the player paid the optional secondary fee in the event the player finishes in one of the secondary payout spots. At 220, the house takes its percentage of the poker tournament fees and optional secondary fees. At 225, a primary payout scheme is generated using the poker tournament fees (e.g., spots equal to 10% of total entrants paid) along with secondary payout scheme based on the number of optional secondary fees paid. Both payout schemes are displayed on tournament monitors such that players are aware of the primary and secondary payout pool amounts and schemes. At 230, the poker tournament begins. At 235, as players are eliminated from the tournament, they are provided with proof of their finishing spot which is tracked by the operator. At 240, the tournament ends when a single player collects all chips. At 245, the primary payout pool is distributed pursuant to the primary payout scheme. At 250, the secondary payout pool is distributed to eligible players (i.e., those paying the optional secondary fee) pursuant to the secondary payout scheme.

In a poker room setting, it is likely that the embodiments of the present invention will be facilitated by software. Poker rooms currently use commercially available software to manage conventional poker tournaments. The commercial software maintains number of entrants, prize pool, payout spots and payout amounts (after the house takes it portion). The software interacts with one or more displays/monitors in the poker room wherein said displays depict tournament levels, number of players remaining, average chip stacks, etc. Accordingly, in one embodiment of the present invention the software is developed to integrate with the commercial software. Alternatively, the software according to the embodiments of the present invention may be completely separate. In either instance, based on user customization, the software according to the embodiments of the present invention automatically tracks the number of secondary optional fees paid and the pool generated thereby.

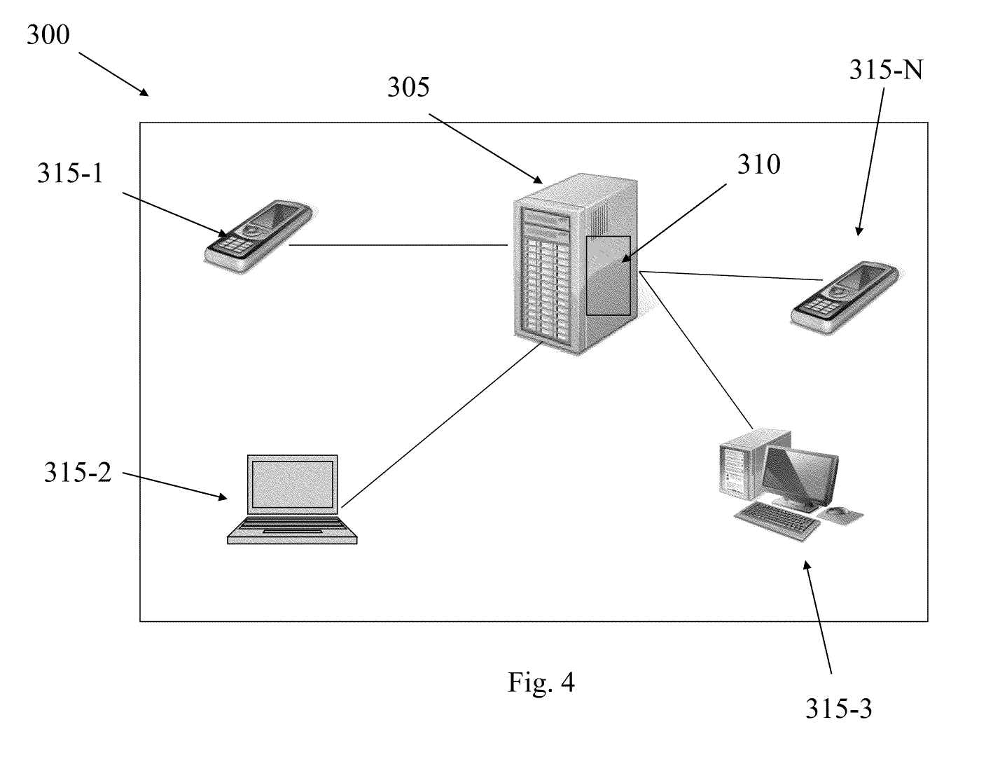

FIG. 4 shows a block diagram of a wireless system 300 which may be used to facilitate remote play of the game according to the embodiments of the present invention. The wireless system 300 comprises a game server 305, including one or more processors 310 running game software, and remote devices 315-1 through 315-N (e.g., smart phones) configured to access said game server 305 facilitating game play on the remote devices 315-1 through 315-N. In another embodiment, the digital, video or online poker game according to the embodiments of the present invention may be in the form of a software application downloadable onto smart phones, tablets or computers and playable via processing power and a user interface associated therewith.

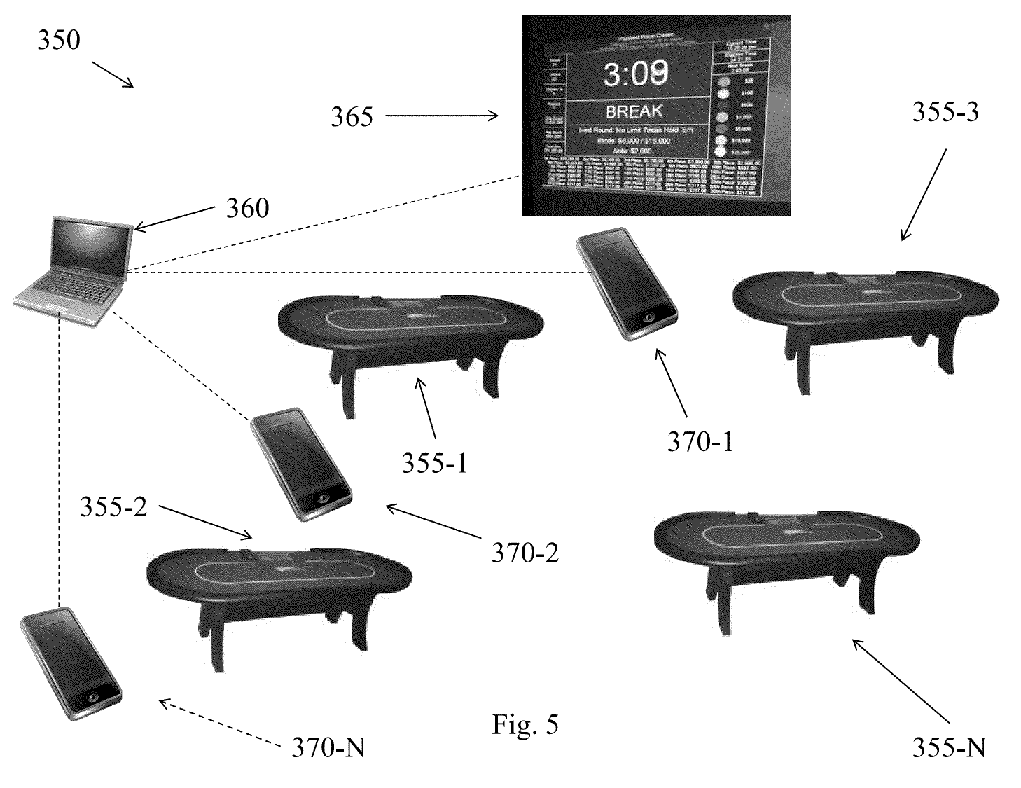

In one embodiment, as shown in FIG. 5, a poker room system 350 includes one or more poker tables 355-1 through 355-N wherein each of said one or more poker tables include at least an automatic shuffler, chip rack and dealer station. The poker tables 355-1 through 355-N may also include a drop box and other accessories. A poker tournament registration system 360 is positioned proximate to said one or more poker tables 355-1 through 355-N. In one embodiment, the registration system 360 is in the form of a computer terminal comprising at least a processor and input device, and printer. The poker tournament registration system is configured to (i) record payment of poker tournament entry fees and optional secondary fees, (ii) generate a receipt including an identifier and/or data code for at least each player paying the optional secondary fee, (iii) determine a primary payout scheme based on number of accepted poker tournament entry fees and (iv) determine a secondary payout scheme based on number of accepted secondary fees. A display 365 communicates with said poker tournament registration system 360 and is configured to display poker tournament information including primary payout scheme and secondary payout scheme information as well as details of the poker tournament (e.g., time remaining in current stage). One or more mobile devices 370-1 through 370-N are configured to read said identifiers and/or data codes from said receipts as players, having paid the optional secondary fee, are eliminated from said poker tournament and associating said identifiers and/or data codes with finishing spots of said players such that said players may be paid, if eligible, according to said secondary payout scheme.

In practice, as players are eliminated from the tournament, a dealer or floor manager utilizes one of said one or more mobile devices 370-1 through 370-N to read the information from the player's receipt. The information read is then stored in a database maintained on the mobile device 370-1 through 370-N or poker registration system 360 or some other computer system in communication therewith. In this manner, the finishing spot of players, including at least those paying the secondary fee can be recorded so that secondary payouts can be made based thereon. In one embodiment, the mobile devices 370-1 through 370-N run a dedicated “App” configured for purposes of reading, storing and/or transmitting player information.

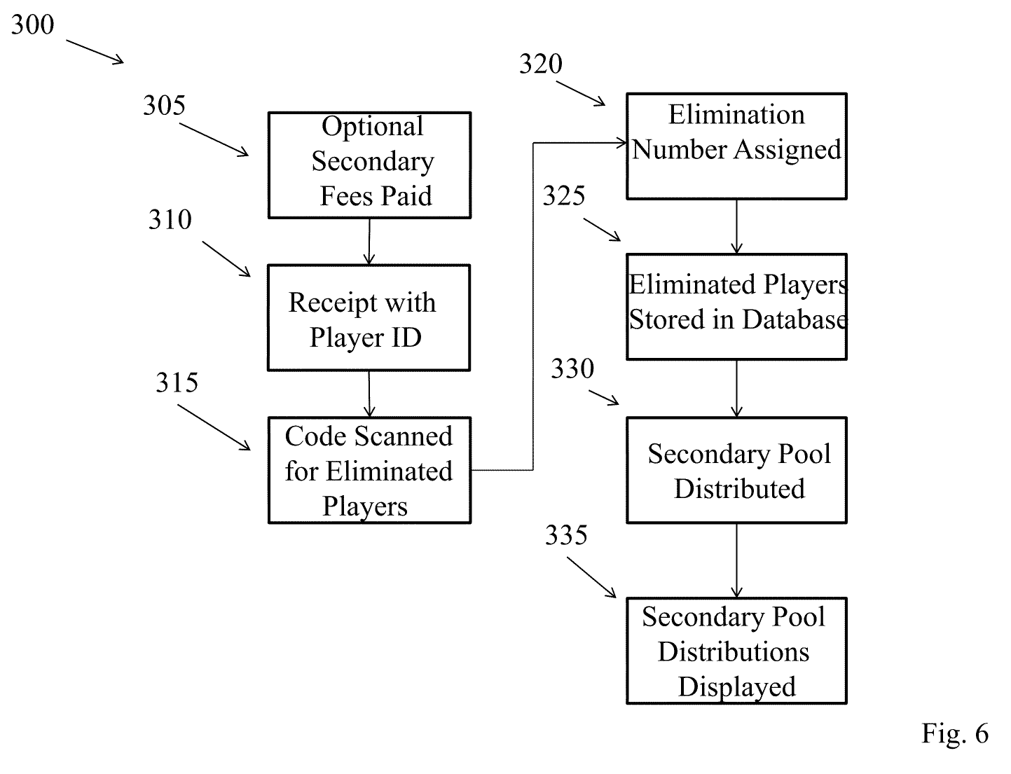

Tracking player spots as they are eliminated or knocked out may be facilitated by smart phone/tablet applications (“Apps”), RFID technology or simple physical articles such as numbered bracelets. Any form of tracking players as they are knocked out of the tournament is conceivable. With smart phone or tablet Apps, a poker room manager and/or dealers download the app on available smart phones or tablets. FIG. 6 shows a flow chart 300 detailing a methodology that operators may use to track players being eliminated from a tournament after paying the secondary fee. At 305, players paying the optional secondary fee and, at 310, are provided with a receipt including a player ID (e.g., number, name or other information for identifying the player) and a designated bar code, QR code or similar code indicative of the player paying the secondary fee. The identifier may or may not be part of the data code. At 315, as players having paid the secondary fee are eliminated from the poker tournament, a poker room manager or dealer scans the bar code, QR code or similar code using an appropriate reader on the smart phone or tablet. At 320, the player ID is associated with the elimination number of the player. For example, the first player eliminated and having paid the secondary fee is assigned number 1 or a finishing spot number (e.g., 78^{th} out of 98^{th} players). At 325, each player being assigned an elimination number or finishing spot is stored in a database maintained by the app and/or poker room software which is communicatively linked to said app. At 330, once the tournament ends or all players having paid the secondary fee are eliminated, the app may randomly (or based on some other protocol) determine which of the players having paid the secondary fee shall be paid from the secondary fee pool. The operator may also use other means to determine which players receive a portion of the secondary fee. At 335, the secondary payout amounts and player IDs may be presented on the poker room displays/monitors.

With an online embodiment, the optional secondary fee is made available for players signing up to play poker tournaments and the Internet server running appropriate poker software manages the additional secondary payouts and how they are made. Indeed, all facets of the live game may be implemented in online embodiments pursuant to well-known technology. In one such embodiment, a computer virtual network utilizing player terminal, such as laptop computers, desktop computers and smart devices, access a central server with a processor or similar running poker software. In a conventional manner, players are able to interact with the poker game using the interface (e.g., keyboard, touch screen display) of the player subject terminal.

Those skilled in the art will recognize that the amount of the optional secondary fees, number of secondary payout spots, amount and structure/scheme of secondary payouts and the like may be modified and optimized as deemed appropriate by the operator offering the same.

Although the invention has been described in detail with reference to several embodiments, additional variations and modifications exist within the scope and spirit of the invention as described and defined in the following claims.

We claim:

1. A poker tournament system comprising:
one or more poker tables, said one or more poker tables each including an automatic shuffler, chip rack and dealer station;
a poker tournament registration system proximate to said one or more poker tables, said poker tournament registration system including at least a computer terminal and printer, and configured to: (i) record payment of poker tournament entry fees and optional secondary fees, (ii) generate a receipt including an identifier and/or data code for at least each player paying the optional secondary fee, (iii) determine a primary payout scheme based on number of accepted poker tournament entry fees and (iv) determine a secondary payout scheme based on number of accepted secondary fees;
a display in communication with said poker tournament registration system, said display for displaying poker tournament information including said primary payout scheme and secondary payout scheme; and
one or more mobile devices configured to read said identifiers and/or data codes from said receipts as players, having paid the optional secondary fee, are eliminated from said poker tournament and associating said identifiers and/or data codes with finishing spots of said players such that said players may be paid, if eligible, according to said secondary payout scheme.

2. The poker tournament system of claim 1 wherein said identifier is a name or number.

3. The poker tournament system of claim 1 wherein said one or mobile devices are in communication with said registration system and/or display.

4. An electronic poker system configured for play over a computer network utilizing player terminals, said terminals including at least a display and user interface, comprising:
one or more servers in communication with said terminals, said one or more servers including one or more processors and configured to:
accept poker tournament entry fees from multiple players prior to a start of said poker tournament, said poker tournament entry fees paid by players via user interfaces of said terminals;
determine a primary payout pool and first payout scheme based on a number of poker tournament entry fees accepted, said primary payout scheme including a number of primary finishing spots to be paid;
accept an optional secondary fee from players prior to a start of said poker tournament, said poker tournament entry fees paid by players via user interfaces of said terminals;
determine a secondary payout pool and secondary payout scheme based on a number of optional secondary fees accepted, said secondary payout scheme including a number of secondary finishing spots to be paid;
record in a database an identifier of each player paying the optional secondary fee and number indicative of a finishing spot of each player paying said optional secondary fee; and
when determinable, pay said secondary finishing spots according to said secondary payout scheme, said secondary payout scheme limited to players paying said optional secondary fee.

5. The system of claim 4 wherein said a processor is further configured to: collect a percentage of said optional secondary fees as operator revenue.

6. The system of claim 4 wherein said a processor is further configured to: establish a number of secondary finishing spots equal to 10% of a number of players paying said optional secondary fee.

7. The system of claim 4 wherein said a processor is further configured to: utilize a secondary payout scheme whereby one or more eligible players are paid an equal amount from said secondary payout pool.

8. The system of claim 4 wherein said a processor is further configured to: utilize a secondary payout scheme involving a tiered system whereby eligible players are paid different amounts from said secondary payout pool.

9. The system of claim 12 wherein said a processor is further configured to: determine secondary finishing spots based on one or more of the following:
(i) an order of finish of eligible players;
(ii) a pre-established grouping of eligible players; and/or
(iii) a random selection of eligible players.

10. The system of claim 4 wherein said a processor is further configured to: limit a number of accepted optional secondary fees.

11. The system of claim 4 wherein said a processor is further configured to: limit said secondary finishing spots to spots outside of said primary finishing spots.

12. The system of claim 12 further comprising one or more monitors for displaying said primary and secondary payout schemes.

13. A method of conducting a poker tournament comprising:
accepting poker tournament entry fees from multiple players prior to a start of said poker tournament;
electronically recording an aggregate of said poker tournament entry fees;
electronically determining a primary payout pool and first payout scheme based on a number of poker tournament entry fees accepted, said primary payout scheme including a number of primary finishing spots to be paid;
accepting optional secondary fees from players prior to a start of said poker tournament;
electronically determining a secondary payout pool and secondary payout scheme based on a number of optional secondary fees accepted, said secondary payout scheme including a number of secondary finishing spots to be paid;
electronically recording an identifier of each player paying the optional secondary fee and a number indicative of a finishing spot of each player paying said optional secondary fee; and
when determinable, paying said secondary finishing spots according to said secondary payout scheme, said secondary payout scheme limited to players paying said optional secondary fees.

14. The method of claim 13 further comprising collecting a percentage of said optional secondary fees as operator revenue.

15. The method of claim 13 further comprising establishing a number of secondary finishing spots equal to 10% of a number of players paying said optional secondary fee.

16. The method of claim 13 further comprising utilizing a secondary payout scheme whereby one or more eligible players are paid an equal amount from said secondary payout pool.

17. The method of claim 13 further comprising utilizing a secondary payout scheme involving a tiered system whereby eligible players are paid different amounts from said secondary payout pool.

18. The method of claim 13 further comprising determining secondary finishing spots based on one or more of the following:
(i) an order of finish of eligible players;
(ii) a pre-established grouping of eligible players; and/or
(iii) a random selection of eligible players.

19. The method of claim 13 further comprising limiting a number of accepted optional secondary fees.

20. The method of claim 13 further comprising limiting said secondary finishing spots to spots outside of said primary finishing spots.

21. The method of claim 13 further comprising permitting said secondary finishing spots to fall within said primary finishing spots.

22. The method of claim 13 further comprising displaying on one or more monitors the primary and secondary payout schemes.

23. The method of claim 13 further comprising using electronic mobile devices to recording each player paying the optional secondary fee and a finishing spot of each player paying said optional secondary fee.
